(19) United States
(12) Patent Application Publication
(10) Pub. No.: US 2003/0169404 A1
(43) Pub. Date: Sep. 11, 2003

(54) Method for exhibiting high-quality three-dimensional motion from a single strip of motion picture film

(76) Inventor: Robert C. Weisgerber, New York, NY (US)

Correspondence Address: DAVID PETER ALAN, ESQ., 81 Second St., South Orange, NJ, 07079, US

(21) Appl. No.: 09/905,838

(22) Filed: Jul. 16, 2001

(51) Int. Cl. G03B 35/08; G03B 35/18

(52) U.S. Cl. 352/60

(57) ABSTRACT

A system is described for three-dimensional motion picture presentation. Films are shown at a high frame rate, such as 48 frames per second, through a projector equipped for double-shuttered display method. Frames intended to be seen through the left eye by the viewers are alternated on the same strip of film with frames intended to be seen through the right eye. Alternation of images between left and right eyes can be accomplished through use of a polarizing filter, the direction of which is electronically switched, so that light passes through complimentary polarizing filters on the glasses worn by the viewers. Alternatively, an infared-activated cueing device can switch between shutters provided as part of the viewers' viewing glasses, so that alternating images are seen through each eye separately. In the invention described here, the three-dimensional feature of presentation can be temporarily withdrawn, so three-dimensional and high-quality two-dimensional presentation methods can be used for different scenes of the same motion picture. In the practice of the invention, the cinematic image fills the entire frame of the chosen film format, and the frame rate of projection is double the frame rate of photography. No special optics are required in the system described.

### BACKGROUND OF THE INVENTION

This invention relates to motion pictures exhibited to movie-going (theater) audiences in a manner that simulates three-dimensional (3-D) viewing. There have been a number of systems in use for photographing and projecting 3-D films, but each possessed undesirable qualities, with which the present invention is not hampered.

The earliest 3-D movies were photographed in black-and-white, through red or green filters. Viewers wore glasses for viewing such films; the glasses consisting of a red lens in front of one eye and a green lens in front of the other. In this manner, the viewer saw one image with the left eye and a slightly different image with the right eye. The difference in images was just enough to compensate for parallax differences between the two eyes of the viewer, and to make it appear as though the screen was at the point of convergence of left-eye and right-eye vision. Clearly, the chromatic aberrations inherent in use of red and green filters made such a presentation method unsuitable for color films.

More recent methods make use of polarized light to distinguish between images for the left eye and those for the right eye (“passive method”), and of a method for briefly and alternately covering the eyes of the viewer, so that only one eye is actually viewing a film image at any given instant (“active method”). In this method, a device cues a mechanism in the glasses worn by the viewers of the film.

In addition to the dichotomy concerning “active” or “passive” method of switching between eyes, there is a further dischotomy of whether the presentation will be made using a single projector or two synchronized projectors.

In the single projector situation, different images intended for the left and right eyes separately are placed side by side, or “over and under” on motion picture film, with one “half-image” above the other on a motion picture film frame (see, e.g., Lipton, U.S. Pat. No. 5,481,321 (1992)). These partial images are converged on projection, to be seen by the viewers as having a “three-dimensional” quality. In this format, when one projector is used, a sophisticated system of optics, including prismatic lenses situated at right angles, is needed to converge the two ajacent images, one of each of which is intended to be seen by each eye of the viewer (see, e.g. Ohno, U.S. Pat. 4,544,247 (1985) (prismatic optics)).

Unfortunately, there are several drawbacks to such a system. The convergence of image components presented in the “over and under” format results in images that are overly wide, in proportion to their height. The “side by side” format delivers images that must be presented in aspect ratios that are very square, in comparison to standard motion picture formats. Otherwise, anamorphic expansion must be used to display images in wide-screen formats. The optical system used in other methods to converge the images and present them in the appropriate format uses a great deal of available light. A system of this sort also requires more magnification than required by conventional films, because the image is smaller than the image in films presented conventionally. The use of greater magnification not only leaves less light available to hit the screen, but also magnifies undesirable artifacts, such as grain, flicker and the jumping and weaving effect of image instability. Anamorphic expansion also takes up light and compromises resolution.

Another method of showing 3-D films uses two projectors, synchronized with each other, a method utilized in the 1950s. Such a system involved all the inherent risk of problems that stems from using two projectors, rather than one. In addition, a metallic screen was required to maintain the integrity of horizontal and vertical polarization, as well as to contribute screen gain to cut back on light loss. In that system, the viewer sees 24 discrete images each second, with 48 flashes of light, through each. eye. Even IMAX Corp., with its large film format (70 mm, 15 perforations per frame) has envisioned using two projectors or else a single projector projecting separate prints containing images for each eye separately. The IMAX system also uses a metallic screen or shuttered glasses.

To use an example, a contemporary 3-D film is photographed in 70 mm format (65 mm frame size), ten perforations per frame. Images in the “over and under” format are to be converged. A special projector lens is required to show such films, since the resultant image should fit the standard 70 mm, 5-perforation format. Each of the viewer's eyes sees only 48 flashes of light per second, so all of the artifacts inherent in exhibition at 24 frames per second are retained. A nonstandard film format is required to store the images, and light levels are compromised. If the two-projector system is used for showing two strips of film, this increases the risk of mechanical failure, lack of proper convergence or other problems that interfere with the quality of the presentation.

Moreover, in each of the existing methods for showing 3-D films. as described here, these systems are always “on” and two-dimensional (2-D) presentation is not feasible, without significant loss of picture quality. The present invention uses a single-projector instead of two, so resolution, brightness, contrast and image stability (freedom from jump and weave, etc.) are not compromised in the system described, thereby delivering a high-quality 2-D presentation.

### BREIF DESCRIPTION OF THE INVENTION

The invention described here presents an improvement in the presentation of 3-D motion pictures, over the prior art, because it allows full presentation using only a single projector, rather than two projectors synchronized with each other. This invention also represents an improvement over previously-known single projector 3-D presentation, since it eliminates the need for the complex prismatic lens system currently needed for single-projector presentation and the image degredation inherent in this methodology.

The central feature of the invention is the use of a projector capable of showing films at a frame rate of forty-eight frames per second, or more, with a double-bladed shutter. Projectors capable of running at higher frame rates (such as sixty frames per second) or more are acceptable, as long as they operate with a double-bladed shutter. The projector must accomplish pulldown of film between frames in six miliseconds or less.

Films can be presented through use of a polarizer to distinguish between images suitable for the left eye or the right eye (“passive method”) or through a cueing device which activates the glasses worn by the viewers of the film to switch between right-eye and left-eye viewing (“active methods”. In either method of practice of the invention, the projector shows a single strip of film, containing images alternating between those intended to be seen with the left eye, and those intended to be seen through the right eye. In the preferred embodiment of the invention, the projector runs at forty-eight frames per second. At that rate, there are twenty-four discrete images for the left eye and another twenty-four images for the right eye, shown every second, in alternating sequence. It can be said that the single projector in the present invention replaces the two projectors used in the prior art, that are synchronized to operate out of phase (one projector flashes the image intended for one eye, while the other projector is at the dark part of its cycle, so the other eye sees no image at that moment). It can also be said that the single projector used in the present invention can present as many discrete images as could a projector showing “over and under” or “side by side” composited images as known in the prior art. In the present invention, however, the optical system required to combine the two images is not needed, so image quality is maintained and no light is lost that would otherwise be lost during the operation of combining the images.

In the polarizing method (“passive method”) of presenting 3-D films according to the present invention, a circular polarizing filter is mounted in front of the projector lens. The polarizer is activated by a switching circuit (or similar means of producing oscillation) to switch between the direction of polarization that allows left-eye viewing (in line with the polarizing filter on the left lens of the glasses worn by the viewers) and the direction that allows right-eye viewing (in line with the polarizing filter on the right lens of the glasses worn by the viewers). In the preferred embodiment of the invention, the direction of polarization will be switched forty-eight times per second, to allow twenty-four discrete images to be viewed by each eye during the course of each second.

If electronically shuttered glasses are worn by the viewers (“active method”), an infared device is used to cue a sensor in the glasses worn by the viewers to switch between opening the shutter over the right lens and the shutter over the left lens, to allow the viewer to observe alternating images through each eye. This infared switching technology is known in the art

An additional novel feature is that, according to the invention described here, it is possible to selectively present some scenes of a motion picture feature film in 3-D, with high-quality two-dimensional (2-D) presentation for other scenes. With the polarizing method, images are still polarized, but they are presented without the component that delivers the illusion of three-dimensionality, so they appear two-dimensional. In the shuttered-glasses method, the device that activates the shuttering mechanism in the glasses can be turned off for 2-D presentation. It is anticipated that the quality of 2-D presentation will be consistant with that taught by Weisgerber in his previous U.S. Patents on high-quality motion picture presentation, U.S. Pat. Nos. 5,627,614 and 6,243,156 (at forty-eight frames per second) and U.S. Pat. No. 5,739,394 (at other frame rates). The compositing system and two-projector system known in the prior art could not be selectively turned off during the exhibition of a single motion picture, as the present invention allows.

### BRIEF DESCRIPTION OF THE DRAWINGS

FIG. 1 shows two strips of motion picture film, to be shown on two different projectors, at twenty-four frames per second, with horizontal or vertical lines to indicate that each strip of film contains images that are polarized differently, to be seen through each of the viewer's eyes, separately.

FIG. 2 shows a single strip of motion picture film, to be shown according to the invention described, at forty-eight frames per second, with alternating directions of polarization, indicating that images are intended to be seen alternately, first by one eye, and the next image to be seen by the other eye.

It should be noted that data, commands, audio information and other nonpicture information is not depicted.

### DETAILED DESCRIPTION OF THE INVENTION

The advances of the invention described here over prior methods of exhibiting 3-D motion pictures can be seen by reference to the drawings.

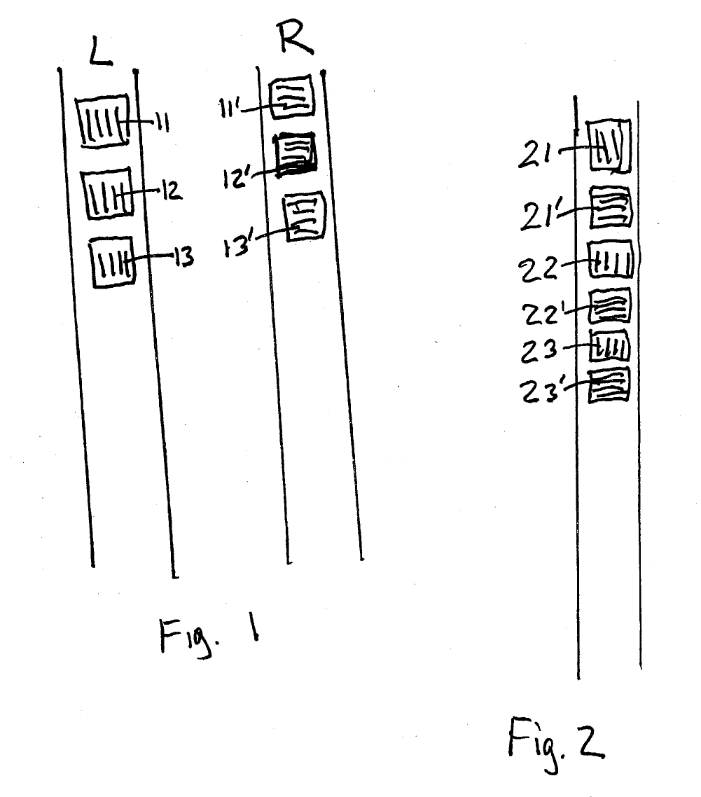

FIG. 1 shows two strips of film, to be shown on two separate projectors. While a frame from Strip L is being exhibited, the projector used to show Strip R is at the blanking part of its cycle, or is otherwise showing darkness. The reverse is true when an image from Strip R is being shown. In this manner, each eye sees a different image, and these images are sequential. First the viewer's left eye sees the image at frame 11, then his or her right eye sees the image at frame 11′. A similar sequence of events occurs with frames 12, 12′, 13 and 13′, as well as all the rest of the frames in the film being viewed. The horizontal and vertical lines in the frames indicate different light polarities for the images intended for the viewer's eyes, and do not necessarily show which way the light will be polarized in any given motion picture. It should also be noted that picture information representing actual content will be present on all frames shown in the drawings, in the practice of this invention (FIG. 2) or the prior art (FIG. 1).

FIG. 2 shows a single strip of motion picture film, where the images from the two strips of FIG. 1 are combined to be shown on a single projector. An image intended to be seen through the left eye is followed by an image intended to be seen through the right eye, and so on.

A strip of film prepared according to the conventional method of 3-D motion picture presentation which involves a single projector may look somewhat like the strip in FIG. 2. In the conventional art, however, the images are resultant images obtained by compositing images placed side by side or “over and under” on each frame. Such images lack the resolution and light brightness delivered by the method described, and the magnification required for this conventional system also magnifies undesirable artifacts.

In the practice of the invention described here, a 3-D film is photographed at a rate such as 24 frames per second and shown on a single projector at double that frame rate (such as 48 frames per second), through a projector equipped with a double-bladed shutter. This delivers 96 flashes of light per second to the viewers in the preferred embodiment; the same number of flashes as two combined projectors operating at 24 fps (for left and right-eyes, separately), but only one projector is needed. This greatly increases image stability and reduces risk of failure, as compared to the two-projector method. In effect, the system described uses one projector to do what two projectors had previously done. Through the use of the 70 mm film format (the preferred embodiment of the invention), the method described will appear to duplicate the special venue use of two projectors or a single projector showing two separate prints. In short, the level of quality of 3-D presentation which previously required two projectors can now be delivered with a single projector.

The use of double shuttering gives an additional advantage over the prior art. With 96 or more flashes of light per second reaching the viewers, the persistence of vision causes the motion as seen by the viewers to appear continuous. Thus, one continuous-looking presentation has replaced two synchronized 24-fps presentations that retain flicker. It is necessary to use a projector capable of high-speed pulldown between frames, preferably six miliseconds or faster. The double-intermittent projector manufactured by Strong-Ballentine Cinema Equipment Co. is suitable for use with the method described. other projectors can be used, but the projector must be capable of operating at at least 48 frames per second, with a double bladed shutter.

In the method described, it is possible to impart the 3-D effect by either shooting the picture with two cameras spaced the appropriate distance apart (conventional 3-D photography) or by photographing a single image as in 2-D presentation and imparting the appearance of a slight difference in images during postproduction. In any event, images are not merged together in the method described. There is also no compromise of brightness, resolution or image stability, compared to a high-impact 2-D presentation at 24 frames per second. In short, the present invention offers the highest resolution and presentation quality available in a 3-D presentation, when the preferred film format of 70 mm is used.

The method described is compatible with two methods of alternating between which of the viewer's eyes sees a specific frame. It is expected that the film will contain a frame to be seen by the left eye (two flashes of light during that frame), followed by another frame intended to be seen by the fight eye (again two flashes), and the process starts with the next left-eye frame. The flashing sequence, then is L/L/R/R/L/L/R/R, and so on, through the entire picture. The images are similar to those which would be seen if two projectors operated synchronously at 24 frames per second, but only one projector is needed. Delivery of alternate frames to each of the viewer's eyes sequentially can be accomplished by use of polarized light or shuttered glasses, both methods now known in the art.

In the polarizing method, an electronically-activated polarizing filter is placed in front of the projector lens. Signals applied to the polarizer activate it to polarize in either of two different orientations, such as horizontal for the left eye and vertical for the right eye (or vice-versa). A circuit designed to oscillate at 48 Hz., for example, will deliver 24 frames to each eye during the course of a second. Viewers will wear glasses with lenses of complimentary polarities, so half of the frames will be seen through each eye. The switching circuit employed can be an astable flip-flop, computerized time marking circuit, or any other device known in the conventional art for synchronization purposes.

Alternatively, information coded onto the film can cue an infared signaling device that signals a device-in the glasses worn by the viewers of the picture to flip between shuttering the left eye or the right eye. Devices of this sort are known in the art. The shuttered glasses (“active method”) allows a matte screen to be used, rather than a metallic screen, so distribution of light is more even over the audience. However, the shuttered glasses are very expensive.

Another advantage of the method described is that it does not waste light in image splitting or combining operations. There are no complex optical systems, since only one projector is showing as many discrete images as were seen with two projectors in the prior art. With light levels of up to 35 footlamberts, a much brighter 3-D presentation is available, compared to conventional art. This allows the full integrity of the image resolution inherent in the film format used for the picture to be maintained.

The method described here is fully compatible with high-impact 2-D presentation, as described previously by the inventor herein in U.S. Pat. Nos. 5,627,614 and 6,243,156 (48 frames per second) and U.S. Pat. No. 5,739,894 (other frame rates), With slight and easy modifications, a projector can show films at 24, 30, or 48 frames per second, or even other frame rates. Three dimensional presentation can be added using the method described here. Moreover, the same projector can show 35 mm or 70 mm film formats by being equipped with two sets of sprockets; the 35 mm sprockets located inside of and parallel to the 70 mm sprockets. A double-bladed shutter is also required.

A further advantage of the method described over conventional 3-D presentation is that it can be “turned off” when the 3-D effect is not needed or desired. Just as the polarizer is switched from one polarity to another to provide vision through each eye alternately, images without the “three-dimensional” component are similarly shown when the “3-D” effect is not desired, and polarized images nonetheless appear two-dimensional. If the alternative method of signalling glasses with internal shutters is used, the signal beam can be turned off temporarily, and the 3-D effect will not be delivered during that time. Thus, scenes where a high visual impact is desirable can be shown in 3-D, while scenes where such an impact is not necessary or desirable can be shown in more conventional 2-D presentation. The “dimensionality” of a film presentation now becomes another parameter to be modulated under the creative control of the filmmaker.

There are as many embodiments to the invention described as there are ways to produce a 3-D presentation. Other frame rates and film formats than those mentioned are possible, although the preferred film format is 70 mm, with five perforations. All other possible embodiments should be considered as lying within the scope of the invention, and the descriptions herein should be considered as illustrative and not limiting.

The invention claimed is:

1. A method for producing and exhibiting three-dimensional motion pictures, comprising: the preparation of a single strip of motion picture film with cinematic images intended to be viewed alternately and sequentially by the left eye and the-next image by the right eye of each of the viewers of said motion pictures, the projection of said strip of motion picture film containing those. images intended to be seen by the right eyes of said viewers and the left eyes of said viewers at double the frame rate at which said film was originally photographed or produced, and allowing only one eye of each of the viewers to see a given image, while allowing only the other eye of each of the viewers to see the next image in sequence.

2. The method as in claim 1, in which a single cinematic image contained on a single frame of motion picture film is shown to only one of the eyes of each viewer of said film, while the next image, contained on the next sequential frame of motion picture film, is shown only to the other eye of each of the viewers of said film.

3. The method as in claim 1, in which each cinematic image is photographed or otherwise prepared as to fill the entire frame according to the film format used.

4. The method as in claim 3, in which the film format used is the 70 mm film format (65 mm film frame) with five perforations per frame.

5. The method as in claim 1, in which said film strip contains images photographed or otherwise produced at twenty-four frames per second and is projected at forty-eight frames per second.

6. The method as in claim 5, in which said films are projected through a double-bladed shutter, to deliver ninety-six flashes of light per second to the viewers of said films.

7. The method as in claim 1, in which said film strip contains images photographed or otherwise produced at a frame rate in excess of twenty-four frames per second, and is projected at a frame rate double that of the frame rate at which said images were originally photographed or otherwise imparted onto said film.

8. The method as in claim 7, in which said films are projected through a double-bladed shutter, to deliver a number of impressions of light per second to the viewers of said films that is four times the number of frames per second at which said films were originally photographed or otherwise produced.

9. The method as in claim 1, in which the means for allowing only one eye of each of the viewers of said films to see a given image, while allowing only the other eye of each of the viewers to see the next image in sequence comprises a polarizing filter through which said films are projected, glasses worn by each of the viewers of said films that allow light polarized in one direction to be seen by the left eye of each of said viewers and light polarized in another direction to be seen by-the other eye of each of said viewers, and a means for switching between directions of polarization of light as projected.

10. The method as in claim 9, in which said switching means completes one switching event after the completion of the showing of an image intended to be seen by the left eye of each of said viewers and before the showing of an image intended to be seen by the right eye of each of said viewers, and said switching means also completes another switching event after the completion of the showing of an image intended to be seen by the right eye of each of said viewers and before the showing of an image intended to be seen by the right eye of each of said viewers of said films.

11. The method as in claim 10, in which said switching means is an astable circuit producing oscillations at the frequency of the number of transitions between eyes intended to occur during each second of the duration of said motion picture films.

12. The method as in claim 10, in which said switching means operates in synchronization with the advance of said film strip.

13. The method as in claim 1, in which the means for allowing only one eye of each of the viewers of said films to see a given image, while allowing only the other eye of each of the viewers of said films to see the next image in sequence comprises the cueing of a signalling device which, in turn, signals a device within the glasses worn by each of the viewers of said films to permit light to go through the glass in front of the left eye of said viewers, or to go through the glass in front of the right eye of said viewers.

14. The method as in claim 13, in which such switching means is activated in response to signals recorded onto the films to be so projected.

15. The method as in claim 10, in which such switching means is activated in response to signals recorded onto the films to be so projected.

16. The method as in claim 1, further comprising a means for removing the three-dimensional nature of the presentation and returning to two-dimensional presentation during the exhibition of portions of said motion picture films, while reinstating the three-dimensional nature of the presentation for other portions of said motion picture films.

17. The method as in claim 16, in which said means comprises the showing of images without preparation that includes the three-dimensional image component, with the result that said images, when. shown through a polarizing filter that changes direction for viewing by either the right or left eye and viewed through glasses with complimentary polarizing filters for each eye, appear to retain a two-dimensional appearance.

18. The method as in claim 16, where such means comprises the deactivation of the means for allowing selective viewing by one eye or the other of the viewers of said films, through use of a signal imparted onto said films that accomplishes cessation of the signal that allows the glasses worn by said viewers of said films to cover one eye or the other of said viewers in response to signals imparted onto said films.

19. A method for exhibiting three-dimensional motion pictures to audiences, where the improvement comprises the use of a single projector, showing a single strip of motion picture film, to project all images to be seen by either the left eye or the right eye of each of the viewers of said motion picture films, at a frame rate of at least twenty-four frames per second for photography and at least forty-eight frames per second for projection, and utilizing the entire film frame for each image to be shown to the viewers of said films.

20. The method as in claim 19, where the improvement further comprises the selective transition between three-dimensional and two-dimensional presentation during the showing of a single motion picture film.
